(19) United States
(12) Patent Application Publication
(10) Pub. No.: US 2019/0135184 A1
(43) Pub. Date: May 9, 2019

(54) VEHICLE VISUAL RECOGNITION DEVICE

(71) Applicant: KABUSHIKI KAISHA TOKAI-RIKA-DENKI-SEISAKUSHO, Aichi (JP)

(72) Inventor: Tomonori ICHIKAWA, Aichi (JP)

(21) Appl. No.: 16/099,318

(22) PCT Filed: May 12, 2017
(86) PCT No.: PCT/JP2017/018096

§ 371 Date: Nov. 6, 2018

(30) Foreign Application Priority Data
May 20, 2016 (JP) 2016-101849

(51) Int. Cl. B60R 1/12; B60R 1/00

(52) U.S. Cl. CPC B60R 1/12; B60R 2011/004; B60R 1/006

(57) ABSTRACT

An imaging device is provided with a rigid member that extends toward a vehicle width direction outside, and a styling case that covers the rigid member. A first rib that projects toward a base portion of the rigid member is provided to the styling case. A projection leading end of the first rib is capable of abutting the rigid member. The rigid member is reinforced by the styling case when the projection leading end of the first rib abuts the rigid member, enabling the rigidity of the imaging device against load to be increased.

### TECHNICAL FIELD

The present invention relates to a vehicle visual recognition device that assists visual recognition by an occupant.

### BACKGROUND ART

In a vehicle side camera device disclosed in Japanese Patent Application Laid-Open (JP-A) No. 2014-231334, a bracket member extends from a vehicle body side, a camera is supported by the bracket member, and a cover member covers the bracket member and the camera.

It is desirable to be able to increase the rigidity of such vehicle side camera devices.

### SUMMARY OF INVENTION

### Technical Problem

In consideration of the above circumstances, an object of the present invention is to provide a vehicle visual recognition device capable of achieving increased rigidity.

### Solution to Problem

A vehicle visual recognition device of a first aspect of the present disclosure includes an extension member that extends from a vehicle body side, a covering member that covers the extension member, a visual recognition section that is supported by at least one of the extension member or the covering member, and that assists visual recognition by an occupant; and a first rib that is provided to the covering member, that extends along an extension direction side of the extension member, and that is capable of abutting the extension member.

In the vehicle visual recognition device of the first aspect of the present disclosure, the extension member extends from the vehicle body side, the covering member covers the extension member, and the visual recognition section is supported by at least one of the extension member or the covering member. The first rib is provided to the covering member, and the first rib extends along the extension direction of the extension member. Note that the extension member and the first rib are capable of abutting each other. One of the extension member and the covering member is thereby reinforced by the other, enabling the rigidity of the vehicle visual recognition device to be increased.

A vehicle visual recognition device of a second aspect of the present disclosure is the vehicle visual recognition device of the first aspect, wherein the first rib projects toward the extension member, and a projection leading end of the first rib is capable of abutting the extension member.

In the vehicle visual recognition device of the second aspect of the present disclosure, the first rib projects toward the extension member and is capable of abutting the extension member. This enables one of the extension member and the covering member to reinforce the other.

A vehicle visual recognition device of a third aspect of the present disclosure is the vehicle visual recognition device of the first or the second aspect, further including a projection that is provided on at least one side of the vehicle body side or the opposite side to the vehicle body side in the extension direction of the extension member, and that is capable of abutting an extension direction end of the first rib.

In the vehicle visual recognition device of the third aspect of the present disclosure, the projection is provided to the extension member, and the projection and the extension direction end of the first rib are capable of abutting each other. This enables one of the extension member and the covering member to reinforce the other.

A vehicle visual recognition device of a fourth aspect of the present disclosure is the vehicle visual recognition device of any one of the first to the third aspect, wherein the first rib projects along an up-down direction.

In the vehicle visual recognition device of the fourth aspect of the present disclosure, the first rib projects along the up-down direction. This enables one of the extension member and the covering member to reinforce the other in the up-down direction.

A vehicle visual recognition device of a fifth aspect of the present disclosure is the vehicle visual recognition device of any one of the first to the fourth aspect, further including a second rib that is provided to the extension member, and that is capable of abutting the first rib.

In the vehicle visual recognition device of the fifth aspect of the present disclosure, the second rib is provided to the extension member, and the second rib and the first rib are capable of abutting each other. This enables one of the extension member and the covering member to reinforce the other.

A vehicle visual recognition device of a sixth aspect of the present disclosure is the vehicle visual recognition device of the fifth aspect, including plural of one of the first rib or the second rib, and the other of the first rib or the second rib is provided between the plural of the one of the first rib or the second rib.

In the vehicle visual recognition device of the sixth aspect of the present disclosure, plural of one of the first rib or the second rib are provided, and the other of the first rib or the second rib is provided between the plural of the one of the first rib or the second rib. This enables one of the extension member or the covering member to reinforce the other.

### Advantageous Effects of Invention

The present invention exhibits the advantageous effect of enabling the rigidity of the vehicle visual recognition device to be increased.

### BRIEF DESCRIPTION OF DRAWINGS

FIG. 1 is a perspective view illustrating an imaging device according to an exemplary embodiment, as viewed obliquely from the upper front of a vehicle.

FIG. 2 is a plan view illustrating an imaging device.

FIG. 3 is a cross-section illustrating an imaging device as viewed from the vehicle front.

FIG. 4 is a cross-section illustrating a vehicle width direction center portion of an imaging device as viewed from the vehicle width direction outside.

FIG. 5 is a cross-section similar to FIG. 3, illustrating an imaging device according to a modified example.

### DESCRIPTION OF EMBODIMENTS

Detailed explanation follows regarding an exemplary embodiment of the present invention, with reference to the drawings.

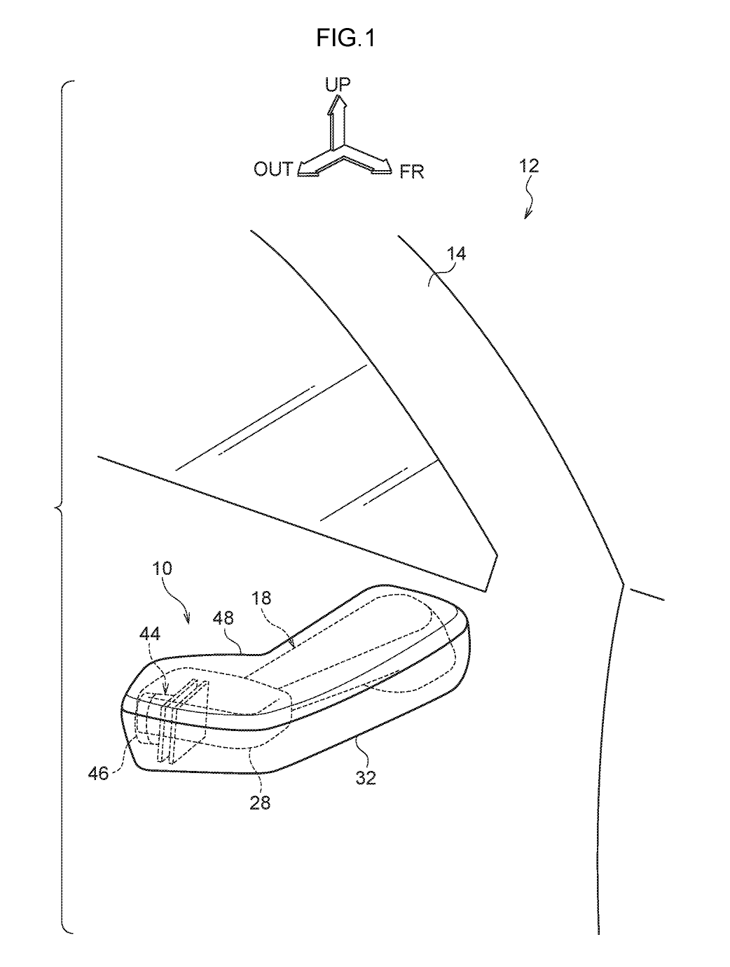

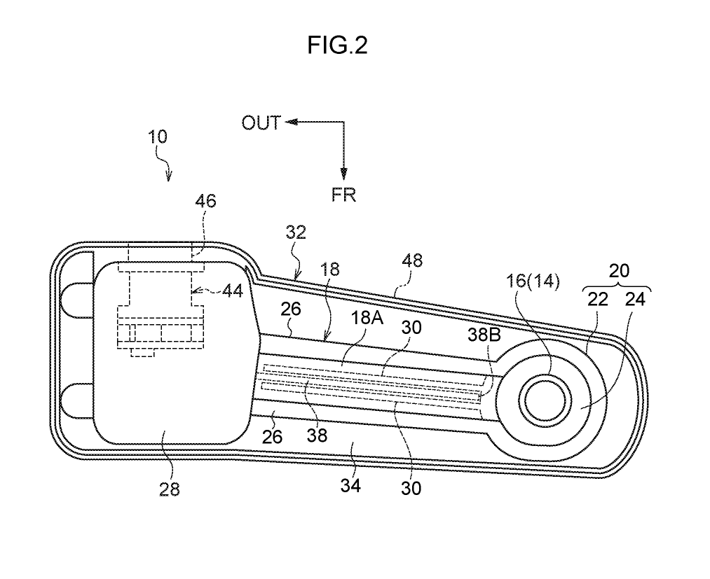

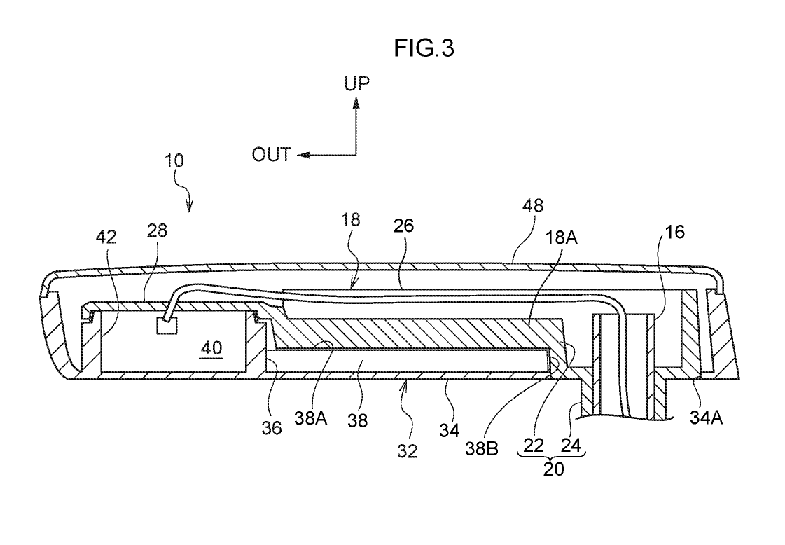

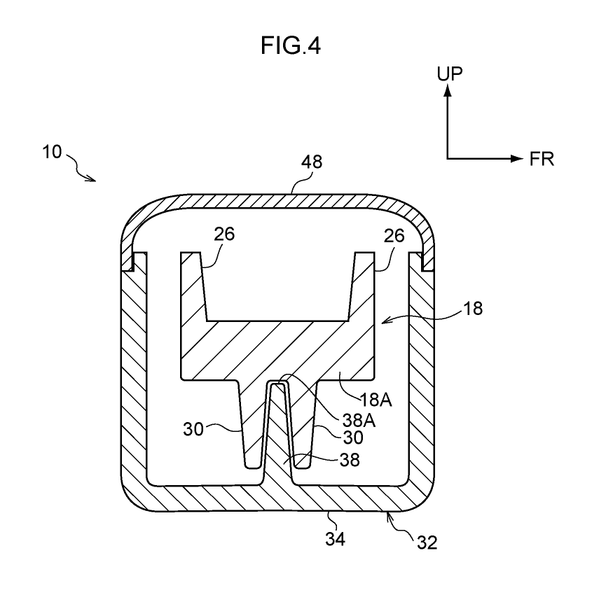

FIG. 1 is a perspective view illustrating an imaging device 10 serving as a vehicle visual recognition device according to the present exemplary embodiment, as viewed obliquely from the upper front of a vehicle, and FIG. 2 is a plan view illustrating the imaging device 10 as viewed from above. FIG. 3 is a cross-section illustrating the imaging device 10 as viewed from the vehicle front, and FIG. 4 is a cross-section illustrating a vehicle width direction center portion of the imaging device 10 as viewed from the vehicle width direction outside (right side). Note that in each of the drawings, the arrow FR indicates the vehicle front, the arrow OUT indicates the vehicle width direction outside (vehicle right), and the arrow UP indicates upward.

As illustrated in FIG. 1, the imaging device 10 according to the present exemplary embodiment is installed at the outer side of a vehicle front side end of an vertical direction intermediate portion of a side door (front side door) 14, serving as a vehicle body side of a vehicle 12. A circular tube shaped support tube 16 (see FIG. 2 and FIG. 3), serving as a vehicle attachment member, is provided to the side door 14. The support tube 16 extends upward, and is disposed with its axial direction parallel to the up-down direction.

As illustrated in FIG. 1 to FIG. 4, an elongated, substantially plate shaped rigid member 18, serving as an extension member, is provided to the imaging device 10. The rigid member 18 is made of metal or made of resin. The rigid member 18 extends from the side door 14 toward the vehicle width direction outside.

As illustrated in FIG. 1 and FIG. 2, an attachment portion 20 is integrally provided to a vehicle width direction inside end portion of the rigid member 18. A tube body 22, serving as a projection, and a rotation shaft 24 are provided to the attachment portion 20. The tube body 22 has a bottomed, circular tube shape, and the rotation shaft 24 has a circular tube shape. The rotation shaft 24 has a smaller diameter than the tube body 22 and is disposed coaxially to the tube body 22. The rotation shaft 24 extends downward from a bottom wall (lower wall) of the tube body 22.

The support tube 16 of a stay (not illustrated in the drawings) assembled to the side door 14 is fitted into the rotation shaft 24, and an upper end portion of the rotation shaft 24 is inserted into the tube body 22. The rigid member 18 is supported by the side door 14 so as to be capable of pivoting in the vehicle front-rear direction about the support tube 16. The pivoting of the rigid member 18 in the vehicle front-rear direction is restricted. However, the rigid member 18 is permitted to pivot in the vehicle front-rear direction when vehicle front-rear direction load corresponding to a specific load or greater is input to the rigid member 18.

An elongated, rectangular flat plate shaped base portion 18A is formed to the rigid member 18 at the vehicle width direction outside of the attachment portion 20. The base portion 18A extends toward the vehicle width direction outside. Upright walls 26 project upward from vehicle front-rear direction end portions of an upper side of the base portion 18A. A vehicle width direction inside end of each upright wall 26 is coupled to a circumferential wall of the tube body 22, and the upright walls 26 extend along the length direction of the rigid member 18. The space between the upright walls 26 is in communication with the inside of the tube body 22.

A substantially rectangular box shaped covered lid 28 is provided at a vehicle width direction outside end portion of the rigid member 18. The interior of the covered lid 28 is open toward the lower side, and the upright walls 26 are coupled to peripheral walls of the covered lid 28.

Plural second ribs 30, serving as second ribs, are integrally provided to a lower face of the base portion 18A. In the present exemplary embodiment, two of the second ribs 30 are provided, and the second ribs 30 are disposed with a specific spacing between each other in the vehicle front-rear direction. Each of the second ribs 30 projects downward from the lower face of the base portion 18A and extends from the circumferential wall of the tube body 22 toward the vehicle width direction outside, such that extension leading ends of the second ribs 30 reach the vicinity of the covered lid 28. The rigidity of the rigid member 18 is increased as a result of providing the second ribs 30.

An elongated, substantially rectangular box shaped styling case 32, made of resin and configuring part of a covering member, is provided peripherally to the lower side of the rigid member 18. The styling case 32 has lower rigidity than the rigid member 18. The inside of the styling case 32 is open toward the upper side, and the rigid member 18 is housed inside the styling case 32. A fitting hole 34A is formed through a vehicle width direction inside end portion of a bottom wall 34 at a lower portion of the styling case 32. A lower end portion of the tube body 22 of the rigid member 18 is fitted into the fitting hole 34A, such that the support tube 16 of the side door 14 and the rotation shaft 24 of the rigid member 18 extend downward from the lower side of a vehicle width direction inside end portion of the styling case 32.

The styling case 32 is fastened and fixed to the rigid member 18, such that the styling case 32 is reinforced by the rigid member 18. The styling case 32 covers the rigid member 18 so as to configure an outer periphery of the imaging device 10 (an outer periphery of the vehicle 12). The styling case 32 also configures a styling face of the imaging device 10.

A covered peripheral wall 36 with a U shape as viewed from the front is provided inside a vehicle width direction outside end portion of the styling case 32. A lower end of the covered peripheral wall 36 is integral in its entirety to the bottom wall 34 of the styling case 32. A vehicle front side portion of the covered peripheral wall 36 is disposed at the vehicle rear side of a vehicle front side wall of the styling case 32. Vehicle rear side ends of a vehicle width direction inside portion and a vehicle width direction outside portion of the covered peripheral wall 36 are integral in their entirety to a vehicle rear side wall of the styling case 32.

As illustrated in FIG. 2 to FIG. 4, a first rib 38, serving as a first rib, is integrally provided to the bottom wall 34 of the styling case 32. The first rib 38 is disposed between the second ribs 30 of the rigid member 18, and the first rib 38 projects upward from the bottom wall 34. The first rib 38 extends from the vehicle width direction inside portion of the covered peripheral wall 36 toward the vehicle width direction inside. The rigidity of the bottom wall 34 of the styling case 32 is increased as a result of the first rib 38 being integrally formed thereto.

A projection leading end 38A of the first rib 38 is disposed direct proximity to the base portion 18A of the rigid member 18. The spacing between the projection leading end 38A and the base portion 18A is narrower than the spacing between projection leading ends (lower ends) of the second ribs 30 of the rigid member 18 and the bottom wall 34 of the styling case 32. An extension leading end 38B at the vehicle width direction inside of the first rib 38 is disposed direct proximity to the vehicle width direction outside of the circumferential wall of the tube body 22. A specific gap is provided between the first rib 38 of the styling case 32 and the second ribs 30 of the rigid member 18. Thus, even if the imaging device 10 vibrates while the vehicle 12 is traveling, the first rib 38 does not contact the base portion 18A, the tube body 22, or the second ribs 30.

A substantially cuboidal housing compartment 40 is configured within the covered peripheral wall 36. A substantially rectangular shaped covered opening 42 is formed at the vehicle front side of an upper face of the covered peripheral wall 36. The covered opening 42 opens the housing compartment 40 toward the upper side and is covered from above by the covered lid 28 of the rigid member 18.

A camera 44, serving as a visual recognition section and an imaging section, is housed in the housing compartment 40. The camera 44 is fastened and fixed to the styling case 32. A controller (not illustrated in the drawings) installed in the vehicle 12 is electrically connected to the camera 44, and the camera 44 is activated by the controller.

As illustrated in FIG. 2, a substantially circular column shaped lens 46 is provided to a vehicle rear side end portion of the camera 44, and the lens 46 passes through a vehicle rear side wall of the housing compartment 40.

The lens 46 is exposed at the exterior of the styling case 32 in a state pointing toward the vehicle rear side, and the camera 44 captures images behind the vehicle when activated. A monitor (not illustrated in the drawings), serving as a display section, is electrically connected to the controller, and a video image (or still image) captured by the camera 44 is displayed on the monitor under the control of the controller. The monitor is disposed in the vehicle cabin, and an occupant of the vehicle 12 is able to check the video image displayed on the monitor (the video image captured by the camera 44), thereby assisting the occupant with visual recognition behind the vehicle.

An elongated, substantially rectangular box shaped styling cover 48, made of resin and configuring part of the covering member, is provided peripherally to the upper side of the rigid member 18. The styling cover 48 has a lower rigidity than the rigid member 18 and the styling case 32. The inside of the styling cover 48 is open toward the lower side, and the entire periphery of the styling cover 48 engages with the entire periphery of the styling case 32, such that the styling cover 48 covers the rigid member 18 and the styling case 32 from above. The styling cover 48 configures an outer periphery of the imaging device 10 (an outer periphery of the vehicle 12), and the styling cover 48 configures a styling face of the imaging device 10 together with the styling case 32.

Explanation follows regarding operation of the present exemplary embodiment.

The imaging device 10 with the above configuration extends from the side door 14 toward the vehicle width direction outside. Thus, for example, if a person (such as a child) were to hang from the imaging device 10, the styling cover 48 would undergo deformation, and a load of a specific amount or greater would be input to the rigid member 18 from the upper side, which might cause the rigid member 18 to flex downward along the vehicle width direction.

Note that the first rib 38 is provided to the bottom wall 34 of the styling case 32, and the projection leading end 38A of the first rib 38 is disposed at the lower side of the base portion 18A of the rigid member 18. Thus, the base portion 18A of the rigid member 18 would abut the projection leading end 38A of the first rib 38. The rigid member 18 is thereby reinforced by the styling case 32, enabling the rigidity of the imaging device 10 against load from the upper side to be increased. Moreover, since the first rib 38 extends along the vehicle width direction, the styling case 32 is reinforced by the first rib 38, also enabling the rigidity of the imaging device 10 against load from the upper side to be increased.

Furthermore, the extension leading end 38B at the vehicle width direction inside of the first rib 38 is disposed in the vicinity of the circumferential wall of the tube body 22 of the rigid member 18. Thus, if the rigid member 18 flexes downward along the vehicle width direction due to load from the upper side, the tube body 22 abuts the extension leading end 38B of the first rib 38. The rigid member 18 is thereby reinforced by the styling case 32, enabling the rigidity of the imaging device 10 against load from the upper side to be increased.

If, for example, the imaging device 10 were to be struck from the vehicle front side or vehicle rear side during vehicle travel, impact load of a specific amount or greater might be input to the styling case 32 from the vehicle front side or vehicle rear side. Note that the rigid member 18 is provided with the second ribs 30, and the second ribs 30 are disposed direct proximity to the vehicle front side and vehicle rear side of the first rib 38. Thus, if impact load were input to the styling case 32 from the vehicle front side or the vehicle rear side, the second ribs 30 would abut the first rib 38, such that the styling case 32 would be reinforced by the rigid member 18. This enables the rigidity of the imaging device 10 against load in the vehicle front-rear direction to be increased.

The second ribs 30 extend along the vehicle width direction, and the rigid member 18 is reinforced by the second ribs 30. Thus, the styling case 32 is reinforced by the second ribs 30, enabling the rigidity of the imaging device 10 against load from the upper side to be further increased.

Inserting the first rib 38 between the second ribs 30 when assembling the styling case 32 to the rigid member 18 enables the styling case 32 to be restricted from moving in the vehicle front-rear direction relative to the rigid member 18. This facilitates assembly of the styling case 32 to the rigid member 18. Moreover, the extension leading end 38B of the first rib 38 is disposed direct proximity to the circumferential wall of the tube body 22 of the rigid member 18, enabling the styling case 32 to be restricted from moving in the vehicle width direction relative to the rigid member 18, and thus further facilitating assembly of the styling case 32 to the rigid member 18.

Note that in the above exemplary embodiment, the first rib 38 is provided such that the extension leading end 38B at the vehicle width direction inside of the first rib 38 is direct proximity to the circumferential wall of the tube body 22 of the rigid member 18. However, there is no limitation thereto, and it is sufficient that at least one extension direction end of the first rib 38 opposes a projection of the rigid member 18, and reaches direct proximity to the projection.

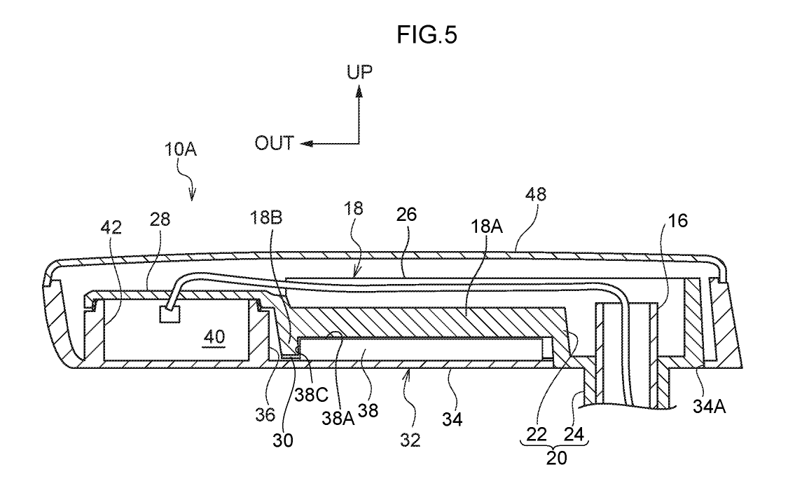

FIG. 5 is a cross-section illustrating an imaging device 10A according to a modified example, as viewed from the vehicle front side. In FIG. 5, the rigid member 18 is provided with a projection 18B, serving as a projection further toward the vehicle width direction inside than the covered lid 28. The projection 18B projects downward from the base portion 18A so as to couple the pair of second ribs 30 of the rigid member 18 together. An extension leading end 38C at the vehicle width direction outside of the first rib 38 of the styling case 32 is disposed direct proximity to the projection 18B.

Thus, if the rigid member 18 flexes downward along the vehicle width direction due to load from the upper side, the base portion 18A and the projection 18B of the rigid member 18 respectively abut the projection leading end 38A and the extension leading end 38C of the first rib 38. This enables the rigidity of the imaging device 10A against load from the upper side to be increased.

Note that in the present exemplary embodiment (including the modified example) explained above, the second ribs 30 are provided to the rigid member 18 so as to sandwich the first rib 38. However, configuration may be such that a single second rib 30 is provided to the rigid member 18, and two first ribs 38 are provided to the styling case 32 so as to sandwich the second rib 30. Alternatively, a single first rib 38 and a single second rib 30 may be provided. Furthermore, the rigid member 18 is capable of abutting the projection leading end 38A and the extension leading end 38B, or the extension leading end 38C, of the first rib 38. However, the rigid member 18 may be configured capable of abutting only the projection leading end 38A, or only at least one of the extension leading end 38B or the extension leading end 38C.

In the present exemplary embodiment (including the modified example), the first rib 38 is provided to the styling case 32. However, a first rib may be provided to the styling cover 48. Moreover, configuration may be such that the first rib 38 is provided to the styling case 32 and a first rib is provided to the styling cover 48.

In the present exemplary embodiment (including the modified example), the imaging device 10 is installed to the side door 14 of the vehicle 12. However, there is no limitation thereto, and the imaging device 10 may be installed to a location of the vehicle 12 other than the side door 14.

In the present exemplary embodiment (including the modified example), the projection leading end 38A, the extension leading end 38B, and the extension leading end 38C of the first rib 38 are respectively disposed direct proximity to the base portion 18A of the rigid member 18, direct proximity to the circumferential wall of the tube body 22, and direct proximity to the projection 18B. However, the projection leading end 38A, the extension leading end 38B, and the extension leading end 38C of the first rib 38 may respectively abut the base portion 18A of the rigid member 18, the circumferential wall of the tube body 22, and the projection 18B.

In the present exemplary embodiment (including the modified example), examples have been given in which the imaging device 10, 10A is provided with the camera 44 serving as a visual recognition section. However, an imaging device serving as a vehicle visual recognition device may include an inbuilt waterproof camera serving as a visual recognition section, or an imaging device serving as a vehicle visual recognition device may be configured by the camera 44 or a waterproof camera attached to the rigid member 18, serving as an extension member. Moreover, in the present exemplary embodiment (including the modified example), examples have been given in which the imaging device 10, 10A is provided with the camera 44 as a visual recognition section. However, the vehicle visual recognition device may be a mirror device provided with a mirror instead of the camera 44, or in addition to the camera 44.

The entire disclosure of Japanese Patent Application No. 2016-101849 filed May 20, 2016 is incorporated by reference in this specification.

1. A vehicle visual recognition device comprising:
an extension member that extends from a vehicle body side;
a covering member that covers the extension member;
a visual recognition section that is supported by at least one of the extension member or the covering member, and that assists visual recognition by an occupant; and
a first rib that is provided to the covering member, that extends along an extension direction of the extension member, and that is configured to abut the extension member.

2. The vehicle visual recognition device of claim 1, wherein the first rib projects toward the extension member, and a projection leading end of the first rib is configured to abut the extension member.

3. The vehicle visual recognition device of claim 1, further comprising a projection that is provided on at least one of a side of the vehicle body or an opposite side from the vehicle body in the extension direction of the extension member, and that is configured to abut an extension direction end of the first rib.

4. The vehicle visual recognition device of claim 1, wherein the first rib projects along a vertical direction.

5. The vehicle visual recognition device of claim 1, further comprising a second rib that is provided to the extension member, and that is configured to abut the first rib.

6. The vehicle visual recognition device of claim 5, wherein one of the first rib or the second rib comprises a plurality of ribs, wherein the other of the first rib or the second rib is provided between the plurality of ribs.

7. The vehicle visual recognition device of claim 1, wherein the visual recognition section includes at least one of a camera or a mirror.
